(19) United States
(12) Patent Application Publication
(10) Pub. No.: US 2019/0130503 A1
(43) Pub. Date: May 2, 2019

(54) SYSTEMS AND METHODS FOR BEVERAGE ORDERING USING A CONTROL DEVICE

(71) Applicant: Noodoe Corporation, Taipei City (TW)

(72) Inventor: John C. Wang, Taipei City (TW)

(21) Appl. No.: 16/174,330

(22) Filed: Oct. 30, 2018

(30) Foreign Application Priority Data
Oct. 31, 2017 (TW) 106137488

(51) Int. Cl. G06Q 50/12; H04W 76/10; G08B 25/10; G06Q 30/04; G06Q 30/06

(52) U.S. Cl. CPC G06Q 50/12; H04W 76/10; H04L 67/12; G06Q 30/04; G06Q 30/0635; G08B 25/10

(57) ABSTRACT

Systems and methods for beverage ordering using a control device are provided. A control device determines a selected surface from a plurality of surfaces according to a motion or a posture, detected by a motion sensor, corresponding to the control device, and wirelessly transmits specific identification data corresponding to the control device and beverage association data corresponding to the selected surface to a management device. The management device identifies a specific table from a plurality of tables according to the received specific identification data, and displays the specific table and the received beverage association data via a display unit.

### BACKGROUND OF THE INVENTION

### Field of the Invention

The disclosure relates generally to systems and methods for beverage ordering, and, more particularly to methods and systems for wirelessly ordering beverages using a control device.

### Description of the Related Art

In the service industry, the best way to increase customer satisfaction is by directly providing appropriate and immediate services to customers. For example, when a customer needs a specific service, such as ordering food, having their water refilled, or receiving the check, the customer always raises a hand to let the waiter noticed the customer's requests. However, during busy times, it is not easy to find a waiter, or the customer's requests cannot be handled in real-time, resulting in customer dissatisfaction.

Currently, wireless service bells have been deployed in some restaurants. Customers can push a service bell set on the table when they need a service. The service bell can wirelessly transmit signals to reception equipment set on a counter or it can be worn by a waiter, so that the customers' requirement can be known by the waiter without delay. However, there are still many problems about the wireless service bells. For example, when receiving the customers' requirement, the waiter may still need to run to the customers to check their demand. It means that the prior art needs multiple rounds of time to confirm their demand. The service efficiency isn't essentially raised.

On the other hand, with the coming of IOT (Internet Of Things), every type of device or object can connect to networks, and users can access and control these devices or objects via networks. The rapid development of IOT is fortunate that the underlying foundation of wireless network technology is already very mature. Electronic devices can readily connect with each other to perform related applications via wireless networks. Additionally, the BLE (Bluetooth Low Energy) technology has solved the prohibitive power consumption issue caused by prolonged connections of electronic devices to wireless networks. There exists an opportunity to provide a more effective and competitive solution of some consumers' easy and clear demands in restaurants and beverage shops, such as ordering beverages, by properly using the IOT technology and integrating the special industry mode of service industry with the IOT technology.

### BRIEF SUMMARY OF THE INVENTION

Systems and methods for beverage ordering using a control device are provided, wherein users can use the control device to wirelessly complete their beverage ordering operation at any time without the need for a waiter.

An embodiment of a system for beverage ordering using a control device comprises a control device and a management device. The control device is set on a specific table, and the control device has a plurality of surfaces. The control device comprises a storage unit, at least one motion sensor, a wireless network connecting unit and a controller. The storage unit is configured to store specific identification data corresponding to the control device and beverage association data corresponding to each of the surfaces. The controller is coupled to the motion sensor and the wireless network connecting unit, configured to determine a selected surface from the surfaces according to the motion or the posture, detected by the motion sensor, corresponding to the control device, and wirelessly transmit the specific identification data corresponding to the control device and the beverage association data corresponding to the selected surface through a wireless network by the wireless network connecting unit. The management device comprises a display unit, a storage unit, a wireless network connecting unit and a processor. The storage unit is configured to store identification data of each of a plurality of candidate control devices, and a relation between each of the corresponding identification data and a plurality of tables. The wireless network connecting unit is configured to receive, by the wireless network, the specific identification data and the beverage association data corresponding to the selected surface. The processor is configured to identify the specific table from the tables according to the received specific identification data and the received relation, and display the specific table and the received beverage association data corresponding to the selected surface via the display unit.

In an embodiment of a method for beverage ordering using a control device, a control device is utilized to determine a selected surface from a plurality of surfaces according to a motion or a posture, detected by a motion sensor, corresponding to the control device, and wirelessly transmits specific identification data corresponding to the control device and beverage association data corresponding to the selected surface. Then, a management device is utilized to wirelessly receive the specific identification data and the beverage association data, identify a specific table from a plurality of tables according to the received specific identification data and the received relation, and display the specific table and the received beverage association data via a display unit.

In some embodiments, the system further comprises at least one wearable device that is worn by a waiter, wherein the wearable device wirelessly receives the specific identification data and the beverage association data corresponding to the selected surface, displays, by a display unit of the wearable device, the specific table and the beverage association data corresponding to the selected surface, and generates a vibration for prompting the waiter through a vibration unit of the wearable device.

In some embodiments, the system further comprises at least one wearable device that is worn by a waiter, wherein the management device transmits a specific signal to the wearable device via the wireless network to notify the waiter to deliver a beverage corresponding to the beverage association data of the selected surface to the specific table.

In some embodiments, wherein the beverage association data comprises a beverage item, or a beverage item and a quantity corresponding to the beverage item.

In some embodiments, the storage unit of the management device further records association information corresponding to the beverage association data corresponding to each of the surfaces and a beverage item, and the management device further provides a user interface for receiving settings corresponding to the association information.

In some embodiments, the system further comprises a billing system coupled to the management device for accumulating a bill corresponding to the specific table according to the received specific identification data and the beverage association data corresponding to the selected surface.

In some embodiments, the control device has a specific surface, and when the controller of the control device determines the specific surface according to the motion or the posture, detected by the motion sensor, corresponding to the control device, the control device uses the wireless network connecting unit to transmit the specific identification data corresponding to the control device and a beverage menu request corresponding to the specific surface to the management device or at least one wearable device through the wireless network, wherein the wearable device is worn by a waiter.

Methods for method for beverage ordering using a control device may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for beverage ordering using a control device of the invention;

FIG. 2 is a schematic diagram illustrating another embodiment of a system for beverage ordering using a control device of the invention;

FIG. 3 is a schematic diagram illustrating an embodiment of a control device of the invention;

FIG. 4 is a schematic diagram illustrating an embodiment of a management device of the invention;

FIG. 5 is a schematic diagram illustrating an embodiment of a wearable device of the invention;

FIG. 6 is a flowchart of an embodiment of the operation of a control device of a method for beverage ordering using the control device of the invention;

FIG. 7 is a flowchart of an embodiment of the operation of a management device or a wearable device of a method for beverage ordering using the control device of the invention;

FIG. 8 is a flowchart of another embodiment of the operation of the management device of a method for beverage ordering using the control device of the invention; and

FIG. 9 is a flowchart of an embodiment of yet another embodiment of the operation of the management device of a method for beverage ordering using the control device of the invention.

### DETAILED DESCRIPTION OF THE INVENTION

Methods and systems for beverage ordering using a control device are provided.

FIG. 1 is a schematic diagram illustrating an embodiment of a system for beverage ordering using a control device of the invention. The system for beverage ordering using a control device 100 comprises a control device 110 and a management device 120. The control device 110 and the management device 120 can be any electronic device having wireless connecting capabilities, and are coupled to each other via a wireless network 130, such as Wi-Fi or Bluetooth network.

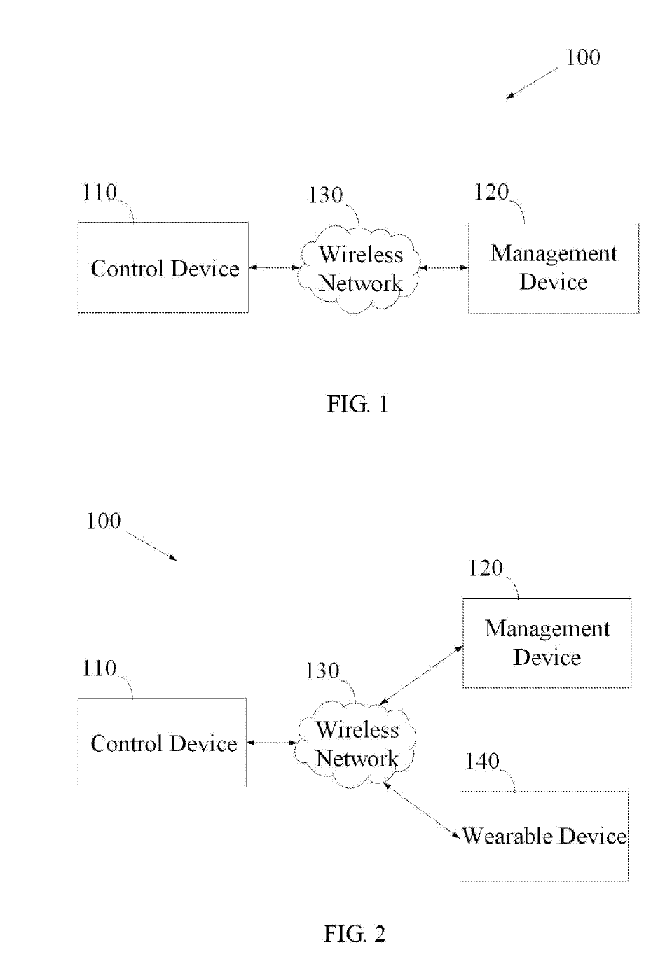

FIG. 2 is a schematic diagram illustrating another embodiment of a system for beverage ordering using a control device of the invention. The system for beverage ordering using a control device 100 comprises a control device 110, a management device 120 and a wearable device 140. As described above, the control device 110 and the management device 120 can be any electronic device having network connecting capabilities, and are coupled to each other via a wireless network 130, such as Wi-Fi or Bluetooth network. Similarly, the wearable device 140 can be any electronic device having network connecting capability and is coupled to the control device 110 and/or the management device 120 via the wireless network 130. It is noted that the wearable device 140 can be a wearable watch that is worn by a waiter in a restaurant.

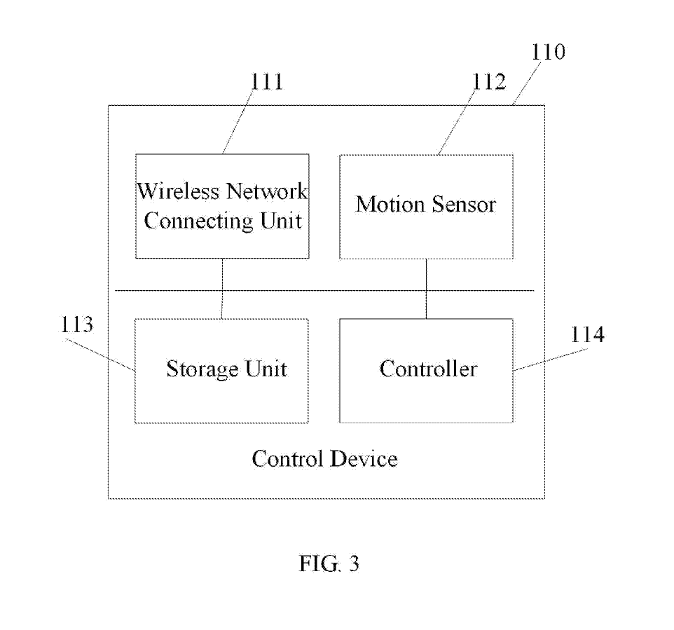

FIG. 3 is a schematic diagram illustrating an embodiment of a control device of the invention. As shown in FIG. 3, the control device 110 comprises a wireless network connecting unit 111, a motion sensor 112, a storage unit 113, and a controller 114. The wireless network connecting unit 111 can connect to other electronic devices having wireless connecting capabilities via a wireless network, such as Wi-Fi or Bluetooth network. It should be noted that, in some embodiments, the wireless network connecting unit 111 may be a network connecting unit implemented with a low-power consumption technology, such as Bluetooth Smart technology. The wireless network connecting unit 111 has two modes, specifically a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless network connecting unit 111 is in the peripheral mode. In other words, the wireless network connecting unit 111 has data broadcasting capabilities, and the wireless network connecting unit 111 cannot actively connect to other electronic devices, wherein the wireless network connecting unit 111 can be passively connected to other electronic devices. It is understood that, in some embodiments, the motion sensor 112 can detect a posture and/or motion corresponding to the control device 110. For example, the motion sensor 112 may be an accelerometer for generating information of velocity and displacement when the control device moves. In another example, the motion sensor 112 may be a Gyro sensor for generating information of angular acceleration when the control device moves. In another example, the motion sensor 112 may be an e-compass for detecting an angle of the control device in regard to a geographical direction, such as the direction of the North Pole or the South Pole. It is noted that, the above sensors are only examples of the present application, and the present invention is not limited thereto. Any sensor that can detect the posture and/or motion of an electronic device can be applied in the present invention. As described, the motion sensor 112 can detect the posture of the control device 110. It is understood that, in some embodiments, the posture can be the angular information of the control device 110 in regard to at least one reference point. In some embodiments, the posture of the control device 110 can be represented by an angle corresponding to an axis which is vertical to at least one plane of the control device 110 in regard to a specific direction, such as the gravity direction or the geographical direction. The storage unit 113 can be a memory for storing specific identification data corresponding to the control device 110. The specific identification data can be used to identify the control device 110. It is noted that, the control device 110 may be set on a specific table and the control device may have a plurality of surfaces. In some embodiments, the control device 110 may have a three-dimensional shape. In other words, the control device 110 can be a cube having six surfaces. Each surface may correspond to one of the beverage association data. It should be noted that in some embodiments, the beverage association data may include a beverage item, or a beverage item and a quantity corresponding to the beverage item. It should be noted that, in some embodiments, the beverage association data can be code data corresponding to the beverage item, or code data of the beverage item and its quantity. It should be noted that, in some embodiments, the control device 110 may have a specific surface, and the specific surface can be a corresponding beverage menu requirement. The beverage association data of each surface can be stored in the storage unit 113. The controller 114 can control related operations of software and hardware in the control device 110. As previously mentioned, the control device 110 may have a plurality of surfaces. The controller 114 can determine one of the surfaces according to the data detected by the motion sensor 112 and generate data corresponding thereto, the details of which will be described later.

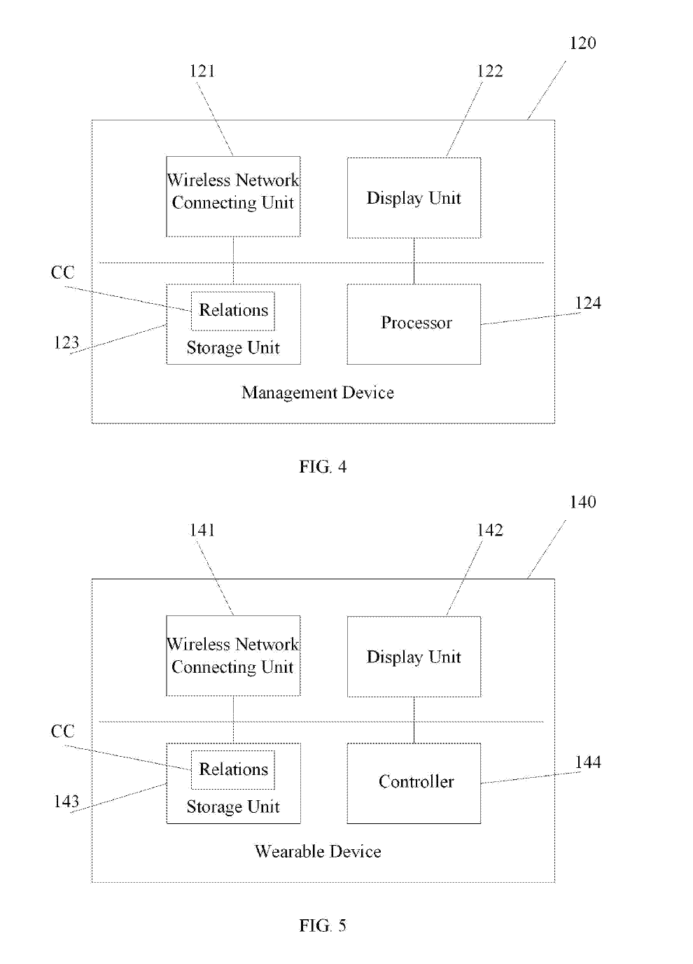

FIG. 4 is a schematic diagram illustrating an embodiment of a management device of the invention. The management device may be a computer or a portable device, such as a mobile phone, a smart phone, a PDA (Personal Digital Assistant), a GPS (Global Positioning System), a notebook, a tablet computer, or a wearable device. As shown in FIG. 4, the management device 120 comprises a wireless network connecting unit 121, a display unit 122, a storage unit 123, and a processor 124. The wireless network connecting unit 121 can connect to other electronic devices having wireless connecting capabilities via a wireless network, such as Wi-Fi or Bluetooth network. It should be noted that, in some embodiments, the wireless network connecting unit 121 may be a network connecting unit implemented with a low-power consumption technology, such as Bluetooth Smart technology. The wireless network connecting unit 121 has two modes, specifically a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless network connecting unit 121 is in the central mode. The display unit 122 can display related information, such as interfaces, images, and/or information. The storage unit 123 can include identification data (not shown) corresponding to each of a plurality of candidate control devices, and a relation CC between each of the respective identification data and a plurality of tables. The processor 124 can control related operations of the software and hardware in the management device 120, the details of which will be described later.

FIG. 5 is a schematic diagram illustrating an embodiment of a wearable device of the invention. As mentioned above, the wearable device can be worn by a waiter in the restaurant. As shown in FIG. 5, the wearable device 140 comprises a wireless network connecting unit 141, a display unit 142, a storage unit 143, and a controller 144. The wireless network connecting unit 141 can connect to other electronic devices having wireless connecting capabilities via a wireless network, such as Wi-Fi or Bluetooth network. Similarly, in some embodiments, the wireless network connecting unit 141 may be a network connecting unit implemented with a low-power consumption technology, such as Bluetooth Smart technology. The wireless network connecting unit 141 has two modes, specifically a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless network connecting unit 141 is in the central mode. The display unit 142 can display related information, such as interfaces, images, and/or information. The storage unit 143 can include identification data (not shown) corresponding to each of a plurality of candidate control devices, and a relation CC between each of the respective identification data and a plurality of tables. The controller 144 can control related operations of the software and hardware in the wearable device 140, the details of which will be described later.

It should be noted that, in some embodiments, the storage unit 123 of the management device 120 may further record the beverage association data corresponding to each of the surfaces and association information of a beverage item, and the management device 120 may further provide a user interface for receiving the settings of the corresponding association information. In other words, the beverage items corresponding to the beverage association data can be changed. When the associated information in the management device 120 changes, the management device 120 can transmit the updated association information to the wearable device 140 via the wireless network.

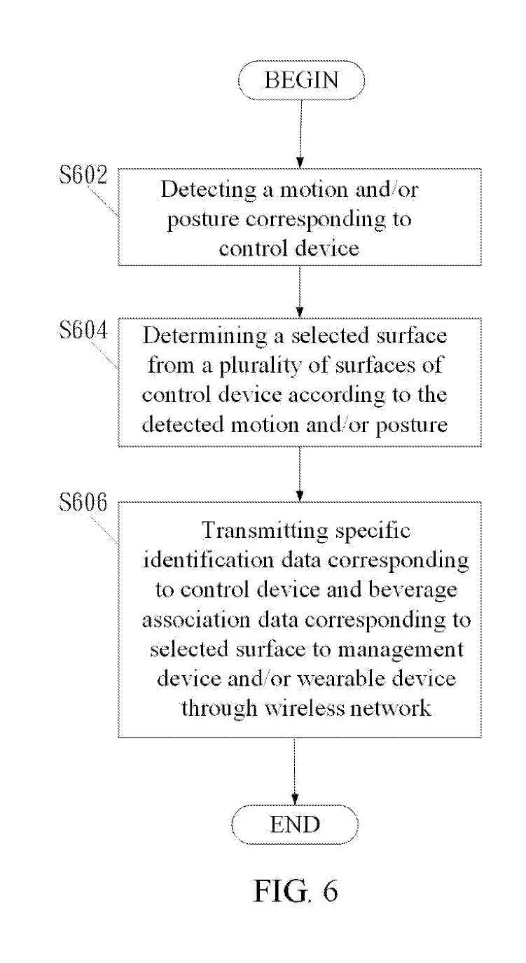

FIG. 6 is a flowchart of an embodiment of the operation of a control device of a method for beverage ordering using the control device of the invention.

First, in step S602, the control device 110 detects a motion and/or posture corresponding to the control device 110 by at least one motion sensor. Similarly, in some embodiments, the motion sensor may be an accelerometer for generating information of velocity and displacement when the control device moves. In some embodiments, the motion sensor may be a Gyro sensor for generating information of angular acceleration when the control device moves. In some embodiments, the motion sensor may be an e-compass for detecting an angle of the control device in regard to a geographical direction, such as the direction of the North Pole or the South Pole. It is noted that, the above sensors are only examples of the present application, and the present invention is not limited thereto. Any sensor that can detect the posture and/or motion of the control device can be applied in the present invention. In step S604, the control device 110 determines a selected surface from a plurality of surfaces of the control device 110 according to the detected motion and/or posture. It is noted that each surface of the control device 110 may correspond to one of the beverage association data. It should be noted that in some embodiments, the beverage association data may include a beverage item, or a beverage item and a quantity corresponding to the beverage item. It should be noted that, in some embodiments, the beverage association data can be code data corresponding to the beverage item, or code data of the beverage item and its quantity. Based on the selected surface, the corresponding beverage association data can be determined. Then, in step S606, the control device 110 broadcasts/transmits the specific identification data corresponding to the control device and the beverage association data corresponding to the selected surface to the management device 120 and/or the wearable device 140 through a wireless network, such as Wi-Fi or Bluetooth network, by a wireless network connecting unit. It should be noted that in some embodiments, the wireless network connecting unit may be a wireless network connecting unit implemented with a low-power consumption technology, such as Bluetooth Smart technology. The wireless network connecting unit has two modes, specifically a central mode and a peripheral mode. In some embodiments, the wireless network connecting unit is in the peripheral mode. In other words, the wireless network connecting unit has data broadcasting capabilities, and the wireless network connecting unit cannot actively connect to other electronic devices, wherein the wireless network connecting unit can be passively connected to other electronic devices.

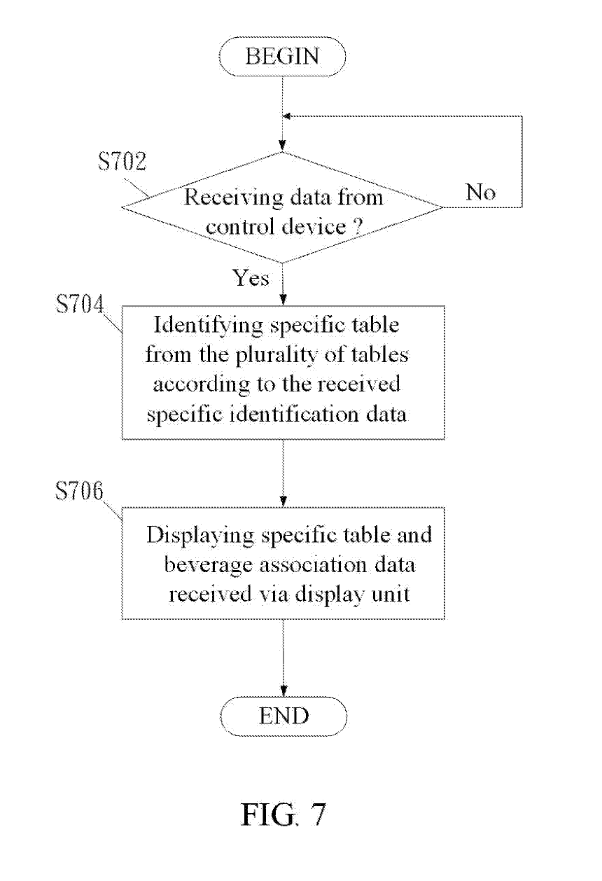

FIG. 7 is a flowchart of an embodiment of the operation of a management device or a wearable device of a method for beverage ordering using the control device of the invention.

First, in step S702, the management device 120 or the wearable device 140 determines whether data from the control device 110 is received. It is understood that data transmitted by the control device 110 comprises the specific identification data corresponding to the control device 110 and the beverage association data corresponding to the selected surface. Similarly, in some embodiments, the wireless network connecting unit of the management device 120 or the wearable device 140 may be a wireless network connecting unit implemented with a low-power consumption technology, such as Bluetooth Smart technology. The wireless network connecting unit has two modes, specifically a central mode and a peripheral mode. In some embodiments, the wireless network connecting unit of the management device 120 or the wearable device 140 is in the central mode. In other words, the wireless network connecting unit of the management device 120 or the wearable device 140 has data receiving capabilities, and the wireless network connecting unit can actively connect to other electronic devices. When the data from the control device 110 has not been received (No in step S702), the determination in step S702 is continued. When the data from the control device 110 has been received (Yes in step S702), in step S704, the specific table is identified from the plurality of tables according to the received specific identification data and the relation CC, and in step S706, t808. It should be noted that in some embodiments, the beverage association data may include a beverage item, or a beverage item and a quantity corresponding to the beverage item. It should be noted that, in some embodiments, the beverage association data can be code data corresponding to the beverage item, or code data of the beverage item and its quantity. When the beverage association data is the code data corresponding to the beverage item or the code data of the beverage item and its quantity, the management device 120 or the wearable device 140 may record a mapping table and retrieve the mapping table according to the received code data to obtain the beverage item, or the beverage item and quantity thereof. It should be noted that in some embodiments, when the wearable device 140 receives the data from the control device 110, a vibration can be generated for prompting the waiter wearing the wearable device via a vibration unit (not shown) of the wearable device.

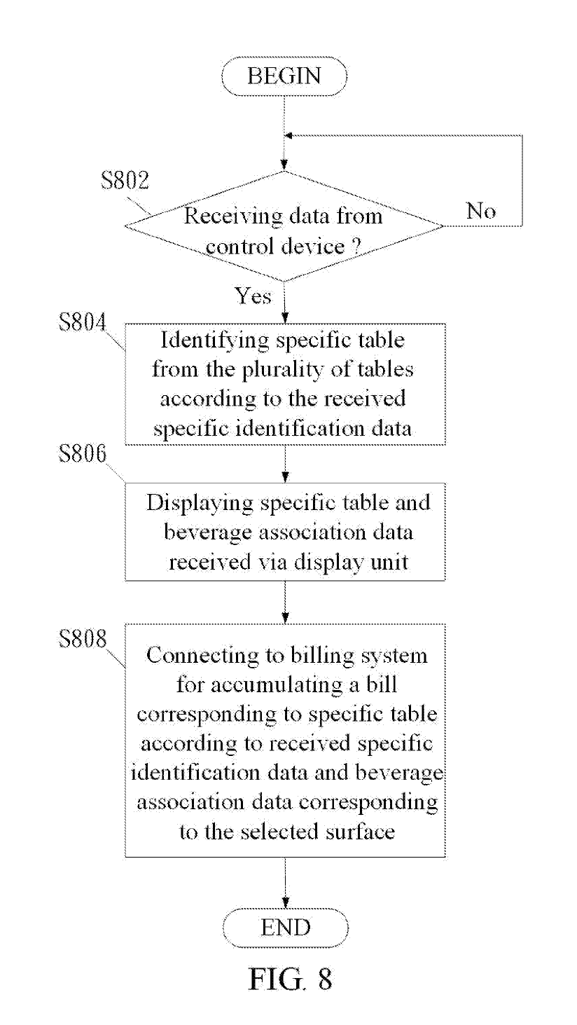

FIG. 8 is a flowchart of another embodiment of the operation of the management device of a method for beverage ordering using the control device of the invention.

First, in step S802, the management device 120 determines whether data from the control device 110 is received. It is understood that data transmitted by the control device 110 comprises the specific identification data corresponding to the control device 110 and the beverage association data corresponding to the selected surface. Similarly, in some embodiments, the wireless network connecting unit of the management device 120 may be a wireless network connecting unit implemented with a low-power consumption technology, such as Bluetooth Smart technology. The wireless network connecting unit has two modes, specifically a central mode and a peripheral mode. In some embodiments, the wireless network connecting unit of the management device 120 is in the central mode. In other words, the wireless network connecting unit of the management device 120 has data receiving capabilities, and the wireless network connecting unit can actively connect to other electronic devices. When the data from the control device 110 has not been received (No in step S802), the determination in step S802 is continued. When the data from the control device 110 has been received (Yes in step S802), in step S804, the specific table is identified from the plurality of tables according to the received specific identification data and relation CC, and in step S806, the specific table and the beverage association data received are displayed via a display unit. Similarly, in some embodiments, the beverage association data may include a beverage item, or a beverage item and a quantity corresponding to the beverage item. It should be noted that, in some embodiments, the beverage association data can be code data corresponding to the beverage item, or code data of the beverage item and its quantity. When the beverage association data is the code data corresponding to the beverage item or the code data of the beverage item and its quantity, the management device 120 may record a mapping table and retrieve the mapping table according to the received code data to obtain the beverage item, or the beverage item and quantity thereof. Thereafter, in step S808, the management device 120 is coupled to a billing system (not shown) for accumulating a bill corresponding to the specific table according to the received specific identification data and beverage association data corresponding to the selected surface.

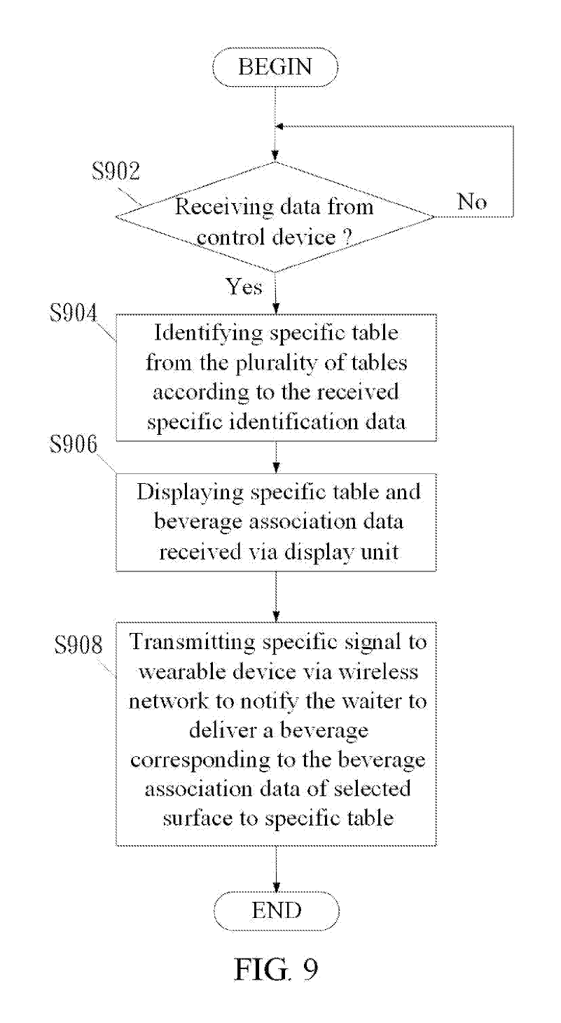

FIG. 9 is a flowchart of an embodiment of yet another embodiment of the operation of the management device of a method for beverage ordering using the control device of the invention.

First, in step S902, the management device 120 determines whether data from the control device 110 is received. It is understood that data transmitted by the control device 110 comprises the specific identification data corresponding to the control device 110 and the beverage association data corresponding to the selected surface. Similarly, in some embodiments, the wireless network connecting unit of the management device 120 may be a wireless network connecting unit implemented with a low-power consumption technology, such as Bluetooth Smart technology. The wireless network connecting unit has two modes, specifically a central mode and a peripheral mode. In some embodiments, the wireless network connecting unit of the management device 120 is in the central mode. In other words, the wireless network connecting unit of the management device 120 has data receiving capabilities, and the wireless network connecting unit can actively connect to other electronic devices. When the data from the control device 110 has not been received (No in step S902), the determination in step S902 is continued. When the data from the control device 110 has been received (Yes in step S902), in step S904, the specific table is identified from the plurality of tables according to the received specific identification data and relation CC, and in step S906, the specific table and the beverage association data received are displayed via a display unit. Similarly, in some embodiments, the beverage association data may include a beverage item, or a beverage item and a quantity corresponding to the beverage item. It should be noted that, in some embodiments, the beverage association data can be code data corresponding to the beverage item, or code data of the beverage item and its quantity. When the beverage association data is the code data corresponding to the beverage item or the code data of the beverage item and its quantity, the management device 120 may record a mapping table and retrieve the mapping table according to the received code data to obtain the beverage item, or the beverage item and quantity thereof. It is noted that after knowing the beverage ordering requirements of a particular table through the display unit, the relevant personnel can prepare relevant beverage items and quantities. Thereafter, in step S908, the management device 120 transmits a specific signal to the wearable device 140 via the wireless network to notify the waiter to deliver a beverage corresponding to the beverage association data of the selected surface to the specific table.

As previously mentioned, in some embodiments, the control device 110 may have a specific surface and the specific surface may correspond to a beverage menu request. When the controller 114 of the control device 110 determines the specific surface according to the motion and/or the posture, detected by the motion sensor 112, corresponding to the control device 110, the control device 110 can use the wireless network connecting unit 111 to transmit the specific identification data corresponding to the control device 110 and the beverage menu request corresponding to the specific surface to the management device 120 and/or the wearable device 140 worn by a waiter through the wireless network.

For example, a control device can be set on a specific table of a restaurant, and a customer can dine at the specific table. The control device can be a cube with six surfaces, wherein one specific surface of the cube can be defined as a beverage menu requirement, while other surfaces can correspond to different beverage association data, such as beverages and their quantities. When the consumer wants to order a beverage, the consumer only needs to flip the control device to a surface corresponding to the specific beverage item and its quantity (the surface is facing up) to complete the beverage ordering process without waiting or asking other consumers at the same table whether they need beverages or other service. At the same time, the management device of the restaurant and/or the wearable device that is worn by the waiter will immediately receive the information, such as the identification data, and the beverage and its quantity of the specific table, transmitted by the control device. Relevant personnel can prepare relevant beverages and deliver them to the specific table.

Therefore, with the methods and systems for beverage ordering using a control device of the present invention, users can use the control device to wirelessly complete their beverage ordering operation at any time and simultaneously perform bill accumulating without the need for a waiter, thus providing the creative and more effective methods for beverage ordering.

Methods for beverage ordering using a control device may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A system for beverage ordering using a control device, comprising:
a control device, wherein the control device is set on a specific table, and the control device has a plurality of surfaces, comprising:
a storage unit configured to store specific identification data corresponding to the control device, and beverage association data corresponding to each of the surfaces;
at least one motion sensor configured to detect a motion or a posture corresponding to the control device;
a wireless network connecting unit; and
a controller coupled to the motion sensor and the wireless network connecting unit, configured to determine a selected surface from the surfaces according to the motion or the posture, detected by the motion sensor, corresponding to the control device, and wirelessly transmit the specific identification data corresponding to the control device and the beverage association data corresponding to the selected surface through a wireless network by the wireless network connecting unit; and
a management device comprising:
a display unit;
a storage unit configured to store identification data of each of a plurality of candidate control devices, and a relation between each of the corresponding identification data and a plurality of tables;
a wireless network connecting unit configured to receive, by the wireless network, the specific identification data and the beverage association data corresponding to the selected surface; and
a processor coupled to the display unit, the storage unit, and the wireless network connecting unit, configured to identify the specific table from the tables according to the received specific identification data and the received relation, and display the specific table and the received beverage association data corresponding to the selected surface via a display unit.

2. The system of claim 1, further comprising at least one wearable device that is worn by a waiter, wherein the wearable device wirelessly receives the specific identification data and the beverage association data corresponding to the selected surface, displays, by a display unit of the wearable device, the specific table and the beverage association data corresponding to the selected surface, and generates a vibration for prompting the waiter through a vibration unit of the wearable device.

3. The system of claim 1, further comprising at least one wearable device that is worn by a waiter, wherein the management device transmits a specific signal to the wearable device via the wireless network to notify the waiter to deliver a beverage corresponding to the beverage association data of the selected surface to the specific table.

4. The system of claim 1, wherein the beverage association data comprises a beverage item, or a beverage item and a quantity corresponding to the beverage item.

5. The system of claim 1, wherein the storage unit of the management device further records association information corresponding to the beverage association data corresponding to each of the surfaces and a beverage item, and the management device further provides a user interface for receiving settings corresponding to the association information.

6. The system of claim 1, further comprising a billing system coupled to the management device for accumulating a bill corresponding to the specific table according to the received specific identification data and the beverage association data corresponding to the selected surface.

7. The system of claim 1, wherein the control device has a specific surface, and when the controller of the control device determines the specific surface according to the motion or the posture, detected by the motion sensor, corresponding to the control device, the control device uses the wireless network connecting unit to transmit the specific identification data corresponding to the control device and a beverage menu request corresponding to the specific surface to the management device or at least one wearable device through the wireless network, wherein the wearable device is worn by a waiter.

8. A method for beverage ordering using a control device for use in a control device and a management device, comprising:
determining a selected surface from a plurality of surfaces according to a motion or a posture, detected by a motion sensor, corresponding to the control device, and wirelessly transmitting specific identification data corresponding to the control device and beverage association data corresponding to the selected surface by using the control device; and
wirelessly receiving the specific identification data and the beverage association data, identifying a specific table from a plurality of tables according to the received specific identification data and the received relation, and display the specific table and the received beverage association data via a display unit by using the management device.

9. A machine-readable storage medium comprising a computer program, which, when executed, causes a device to perform a method for beverage ordering using a control device, wherein the method comprises:
using a control device to determine a selected surface from a plurality of surfaces according to a motion or a posture, detected by a motion sensor, corresponding to the control device, and wirelessly transmit specific identification data corresponding to the control device and beverage association data corresponding to the selected surface; and
using a management device to wirelessly receive the specific identification data and the beverage association data, identify a specific table from a plurality of tables according to the received specific identification data, and display the specific table and the received beverage association data via a display unit.
